(19) United States
(12) Patent Application Publication
(10) Pub. No.: US 2004/0034453 A1
(43) Pub. Date: Feb. 19, 2004

(54) Vehicle data display system and method

(76) Inventor: Werner Funk, Olivenhain, CA (US)

Correspondence Address: Peter R. Martinez, Esq., Suite 200, 11988 El Camino Real, San Diego, CA, 92130, US

(21) Appl. No.: 10/218,372

(22) Filed: Aug. 13, 2002

(51) Int. Cl. G06F 19/00

(52) U.S. Cl. 701/1; 701/123; 701/201

(57) ABSTRACT

A vehicle data display system, method and article of manufacture are provided. The vehicle data display system of the present invention communicates with a vehicle network through a connector located in the vehicle passenger compartment and displays and manipulates the data obtained from the vehicle network. One embodiment of the present invention includes a computer program product for directing a general purpose digital computer to obtain specific vehicle data from the vehicle network and manipulate the data to obtain a vehicle power. The vehicle power represents a power that is generated at a driving wheel of the vehicle, thereby allowing an enthusiast or technician to obtain a power value that represents the power delivered to the vehicle's wheels.

### FIELD OF THE INVENTION

The present invention generally relates to data acquisition and generation. More particularly, the invention concerns a method and apparatus to obtain, display and manipulate vehicle data obtained from a vehicle network.

### BACKGROUND OF THE INVENTION

Modern vehicles contain several on-board computers that are responsible for the operation, and regulation of many systems such as the engine ignition system, the cruise control system, and the anti-lock brake system, to name but a few. The vehicle computers rely upon multiple sensors to operate the various vehicle systems. These sensors monitor a host of vehicle functions such as engine ignition timing, engine coolant temperature, wheel speed, and other functions. Generally, all of the vehicle's sensors are interconnected by a wired or wireless network. If a problem arises, one or more sensors will report through the network to at least one computer and one of the computers will usually generate a Diagnostic Trouble Code (“DTC”) error message.

Included within the vehicle's computer network is an on-board diagnostic system that stores these DTC's, for later review by a mechanic. On-board diagnostic systems were first installed by vehicle manufacturers in the 1980s. Generally, on-board diagnostic (OBD) systems monitor, control and record various vehicle systems and components. In 1990, Congress amended the Clean Air Act to require the Environmental Protection Agency to mandate and regulate installation of OBD systems in all new vehicles. Subchapter II of the Clean Air Act vests in the federal government the almost exclusive responsibility for establishing guidelines for OBD systems. One state, California, is permitted to establish its own OBD system regulations. As vehicle designs evolve, so have OBD system requirements.

Today, the OBD system standard is OBD-II. Virtually all vehicles built since 1996 have this OBD system, and most vehicle manufactures use one of three computer communication protocols to enable the transfer of DTCs and other vehicle data from the OBD-II system to a scan tool or console. The scan tool connects to the OBD-II system through a federally mandated standardized connector plug that is easily accessible from the passenger compartment.

Most vehicle owners become aware of the OBD system when their “Check Engine Light” display appears on their dashboard. The automobile service industry calls the Check Engine Light a “MIL” or Malfunction Indicator Light. To determine what has caused the MIL, a mechanic attaches a scan tool to the OBD connector, which displays OBD data. Scan tools can range from a simple hand-held meter that provides a simple read-out of the various sensor data or signals, up to a large console unit costing thousands of dollars. These scan tools or consoles are generally compatible with most OBD equipped vehicles and contain software that enables the display of data received from the vehicle's OBD system.

Because of their investment in this equipment, most service shops charge a fee to attach a scanning tool and diagnose the problem that set the MIL. However, with the introduction of more economical and user-friendly scan tools, it is now practicable for the home mechanic and small shop technician to access the OBD system. These scan tools vary widely in the amount and type of data that they can read, with some showing just the basic OBD signals, and others showing the full range of OBD service codes.

While the vast number amateur home mechanics only wish to find out why their Check Engine Light is on, many others want to learn more about their vehicle's performance. However, none of the available scan tools manipulate the data available from the OBD system to obtain vehicle performance. Instead, conventional scan tools simply display data downloaded from the vehicle's OBD system.

Therefore, there exists a need for a device that can display vehicle data obtained from a vehicle network, as well as manipulate the data to provide additional vehicle information for the mechanic or vehicle enthusiast.

### SUMMARY OF THE INVENTION

In order to overcome the deficiencies with known, conventional scan tools, a system, method and article of manufacture to obtain and display vehicle data is provided. Briefly, the vehicle data display system of the present invention communicates with a vehicle network through a connector located in the vehicle passenger compartment and displays and manipulates the data obtained from the vehicle network.

More specifically, one embodiment of the present invention comprises a computer program product for directing a general purpose digital computer to obtain specific vehicle data from the vehicle network and manipulate the data to obtain a vehicle power. The vehicle power represents a power that is generated at a driving wheel of the vehicle, thereby allowing an enthusiast or technician to obtain a power value that represents the power delivered to the vehicle's driving wheels.

Another embodiment of the present invention comprises a computer program product for directing a general purposes digital computer to obtain data from a vehicle network and manipulate the data to obtain a vehicle torque. The vehicle torque represents a torque generated by the vehicle's engine. Another embodiment of the present invention comprises a computer program product for directing a general purpose digital computer to obtain data from a vehicle network and generate a vehicle fuel economy. Other embodiments of the present invention can use data obtained from a vehicle network to obtain acceleration times over a distance established by a user of the general purpose digital computer as well as specific distances, such as a quarter mile.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a schematic diagram of a vehicle data display system employing a display unit containing computer readable program code constructed according to the present invention;

FIG. 2 is an illustration of a computer display of vehicle driving wheel power and torque generated by a computer readable program code constructed according to the present invention;

FIG. 3 is an illustration of a computer display of vehicle acceleration generated by a computer readable program code constructed according to the present invention; and

FIG. 4 is an illustration of a computer display of a vehicle fuel economy generated by a computer readable program code constructed according to the present invention.

It will be recognized that some or all of the Figures are schematic representations for purposes of illustration and do not necessarily depict the actual relative sizes or locations of the elements shown.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Modern vehicles contain several on-board computer processors, modules, sensors and other components that are responsible for the operation and regulation of many vehicle systems. Generally, these devices are interconnected by a vehicle network. Most vehicle networks also include an on-board diagnostic system (OBD). OBD systems are in most cars and light trucks on the road today. Through the years, the vehicle network, and the OBD system have become more sophisticated.

One embodiment to the present invention obtains, and manipulates vehicle data from a vehicle network through a connector located in the vehicle passenger compartment. A preferred embodiment of the present invention obtains the vehicle data through an OBD connector.

As defined herein, a “vehicle network” is a group of points or nodes connected by communication paths. Generally, these points or nodes in a vehicle represent modules, sensors or computer processors. These various devices may be joined by a single wire or multiple wires and may be included within one or more discreetly wired networks that either communicate or do not communicate with each other. A vehicle network as defined herein may comprise, in whole or in part, an OBD system employing an SAE J1850 communication protocol, an ISO 9141 communication protocol, or an ISO 9141-2 communication protocol (also known as an ISO 9141 CARB). A vehicle network as defined herein may also employ an ISO 14230 standard, or a KWP 2000 standard. A vehicle network as defined herein may also comprise a Controller Area Network (CAN). The CAN may use ISO 11898, ISO 11519, or other protocols. For example, a vehicle network as defined herein may employ a single wire CAN that uses an SAE J2411 communication standard, a J1939 standard generally found on heavy trucks and buses, a J1708 communication standard or other standards yet to be developed. For example, the vehicle network as defined herein may also employ architectures and communication protocol standards yet to be developed, such as an Intelligent Transportation Systems Data Bus (IDB), or an OBD-III or an OBD-IV standard. A vehicle network as defined herein may employ an IDB communication protocol standard such as J2355, J2366, J2367 and J2368.

An OBD system, as defined herein, may have the capabilities and may perform the functions as proscribed by the United States Code of Federal Regulations (CFR) Title 40 CFR Section 86.094-17, which is referred to and incorporated herein in its entirety by this reference. In addition, an OBD system, as defined herein, may have the capabilities and may perform the functions as proscribed by the California Code of Regulations (CCR) Title 13 Section 1968.1, which is referred to and incorporated herein in its entirety by this reference. In addition, an OBD system, as defined herein, may also have additional capabilities and may perform additional functions not described in the above-incorporated documents.

A preferred embodiment of the present invention is configured to communicate with an OBD-II system. Currently, there are three basic OBD-II protocols in use, each with minor variations on the communication pattern between the OBD computer and the scan console or tool. For example, Chrysler products and most European and Asian vehicles generally use ISO 9141 standard protocols (CHRYSLER is a trademark of Daimler Chrysler of Auburn Hills, Mich.). General Motors vehicles generally use SAE J1850 VPW (variable pulse width modulation) and Ford vehicles generally use SAE J1850 PWM (pulse width modulation) communication protocols (GENERAL MOTORS is a trademark of General Motors Corporation of Detroit, Mich., and FORD is a trademark of Ford Motor Company of Dearborn, Mich.).

The SAE J1850 communications protocol was officially adopted by SAE as the standard protocol for in-vehicle networks in 1994. Today, SAE J1850 is implemented in a variety of production vehicles for diagnostics and data sharing purposes. For example, the SAE J1850 communication protocol enables an inter-module, or inter-sensor data communication network for the sharing of information passed in frames, or messages, between all vehicle electronic modules, nodes and sensors connected to a common bus.

Similarly, ISO 9141 is another communication protocol used in an inter-module, or inter-sensor data communication network for the sharing of information passed in frames, or messages, between all vehicle electronic modules, nodes and sensors connected to a common bus. It employs a serial data communication bus between the vehicle's nodes, modules or sensors and the scan tool. As mentioned above, most European and Asian manufactured vehicles use the ISO 9141 communication protocol.

Most vehicles manufactured since 1996 include an OBD connector located in the passenger compartment area. The OBD connector connects to the vehicle network and can be used to obtain vehicle data. For example, when a “Check Engine Light” indicator appears on a vehicle dashboard the vehicle owner takes the vehicle to a local service station. The mechanic or technician connects a scan tool to the OBD connector in the passenger compartment and obtains a Diagnostic Trouble Code (DTC) that set off the “Check Engine Light” indicator. The technician can then determine a course of action to fix the component that set the DTC. For example, a DTC may be set when the vehicle ECU, or computer processor, no longer receives data from an oxygen sensor or receives data indicating that a fuel injector is misfiring. Conventional scan tools used by today's technicians to obtain vehicle data simply display the data obtained from the vehicle OBD system. Conventional scan tools do not manipulate the vehicle data to generate additional data not provided by the OBD system or the vehicle network.

The present invention provides software programs, or computer readable program code to manipulate data obtained from a vehicle network. One embodiment of the present invention provides software programs or modules to generate data relating to several aspects of vehicle performance, such as vehicle power, vehicle torque, vehicle fuel economy and vehicle acceleration and deceleration. The software program may be stored or placed on a compact disk, a floppy disk, a memory module such as a flash memory device and may also be stored on a general purpose computing device and may be accessed and/or downloaded via a global computer network such as the Internet.

The present invention contemplates the use of personal digital assistants (PDAs), laptops, hybrid phone/PDAs and other general purpose digital computers to obtain data from a vehicle network or OBD system. The various general purpose digital computers will employ one or more software programs or modules to obtain and manipulate vehicle data received from the vehicle network.

With the proliferation of small, powerful computers such as Personal Digital Assistants (PDA's), technicians, mechanics and vehicle enthusiasts will be able to employ these devices instead of conventional scan tools to obtain, and manipulate data from the vehicle network. In addition, laptop computers, hybrid phone/PDA units, electronic organizers, electronic notepads, and hand-held computers can also be employed to obtain and manipulate data from the vehicle network. For example, any number of different PDA platforms such as a PALM, HANDSPRING, TRW, SONY, HEWLETT-PACKARD, COMPAQ, SHARP, NEC or other PDA platforms can be employed to obtain data from the vehicle network or OBD system (PALM is a trademark of Palm, Inc., of Santa Clara, Calif.; HANDSPRING is a trademark of Handspring, Inc., of Palo Alto, Calif.; TRW is a trademark of TRW, Inc., of Cleveland, Ohio; SONY is a trademark of Sony Corporation of Tokyo, Japan; HEWLETT-PACKARD is a trademark of Hewlett-Packard Company of Palo Alto, Calif.; COMPAQ is a trademark of Compaq Computer Corporation of Houston, Tex.; SHARP is a trademark of Sharp Corporation of Osaka, Japan; NEC is a trademark of NEC Corporation of Tokyo, Japan). One skilled in the art will appreciate that the present invention can be employed on virtually any type of device containing a general purpose digital computer.

A preferred embodiment of the present invention employs a PDA to obtain and manipulate data obtained from an OBD-II system. The data may be generated by any vehicle computer processor, electronic control unit, module or sensor. For example, the present invention may obtain and manipulate data relating to fuel and air metering, mass or volume air flow, intake air temperature, engine coolant temperature, throttle/pedal position, O₂ sensor function(s), fuel temperature, fuel rail pressure, engine oil temperature, injector circuit function(s), fuel pump function(s), engine speed, crankshaft position, ignition coil function(s), fuel level, exhaust pressure, vehicle speed, engine oil pressure, power steering function(s), cruise control system function(s), transmission function(s), among others.

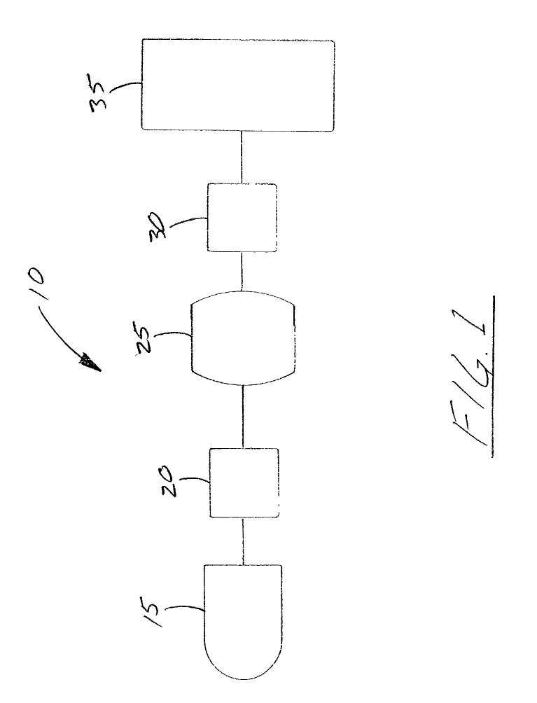

Referring to FIG. 1, components of the present invention are illustrated. FIG. 1 is a schematic illustration of a vehicle data display system 10. A vehicle (not shown) contains a vehicle OBD connector 15 that is generally located in a passenger compartment area. The vehicle OBD connector 15 connects to a vehicle network that may employ any one of the OBD-II communication protocols, as described above. A display unit 35 connects to the vehicle OBD connector 15 through one or more cables and/or interface devices to obtain vehicle data from the vehicle network. The display unit 35 can be virtually any type of general purpose digital computer, but preferably is a PDA, as described above. The display unit 35 contains one or more computer useable storage mediums (such as random access memory, read only memory, flash memory, etcetera.) that have one or more computer readable programs, or software modules constructed according to the present invention stored thereon.

An OBD interface 20 comprises a wire cable having an OBD coupler configured to removably attach to the vehicle OBD connector 15. The OBD interface 20 also includes a RS232 connector, or other suitable connector that is sized to couple to a protocol converter 25.

The protocol converter 25 includes a general purpose computing device such as an RISC microcomputer or other suitable general purpose computing devices, as well as other commercially available components, that perform interface functions for interfacing the display unit 35 with the vehicle network. The protocol converter 25 includes one or more software modules, or computer readable program codes to communicate with a variety of vehicle network, or OBD communication protocols, such as ISO 9141-2, SAE J1850 (VPW or PWM) or other OBD or other vehicle network protocols. For example, the protocol converter 25 may establish a connection with a vehicle OBD-II system employing a SAE J1850 VPW communication protocol. Once a connection is established, the protocol converter 25 waits for the user of display unit 35 to send a request for OBD-II data.

However, the display unit 35 will send a data request using a RS232 system communication protocol. The protocol converter 25 must then convert the RS232-formatted request into a format recognized by the vehicle OBD-II system. Once the request is converted from the RS232 communication protocol to the OBD-II communication protocol, the protocol converter 25 transmits a command to retrieve the specific OBD-II data, such as throttle position, oxygen sensor status or wheel speed. When the OBD-II data is obtained, the protocol converter 25 then reverses the protocol conversion sequence, and converts the data, which is formatted in an OBD-II communication protocol, to a RS232 communication protocol format. In this fashion, the display unit 35 can communicate with a vehicle network to obtain vehicle data. The necessary components and software used to construct a protocol converter 25 can be located at several places on the Internet.

The protocol converter 25 couples to the display unit 35 through a data cable 30. The data cable 30 may include an RS232 connector for removably coupling to the protocol converter 25, and a universal connector, or other suitable connector for removably coupling to a universal connector port on the display unit 35.

Other cable and connector arrangements may be employed to couple the protocol converter 25 and the display unit 35 to the vehicle OBD connector 15. For example, a male-male, null modem adapter may be employed to connect the display unit 35 to the protocol converter 25. Alternatively, a serial adapter comprising an RS232 plug and a universal connector plug may be employed to connect the display unit 35 to the protocol converter 25. One skilled in the art will appreciate that other arrangements of data cables 30, interfaces 20, and other plugs and cables can be employed to connect the display unit 35 to the vehicle OBD connector 15.

A preferred embodiment of the present invention employs a display unit 35, such as a PDA to display and manipulate vehicle data obtained from the vehicle network or OBD system. In contrast to conventional vehicle data display systems, the present invention manipulates the vehicle data to generate new vehicle performance data, such as vehicle power, vehicle torque, vehicle fuel economy and vehicle acceleration. This vehicle information may then displayed numerically and graphically on the display unit 35.

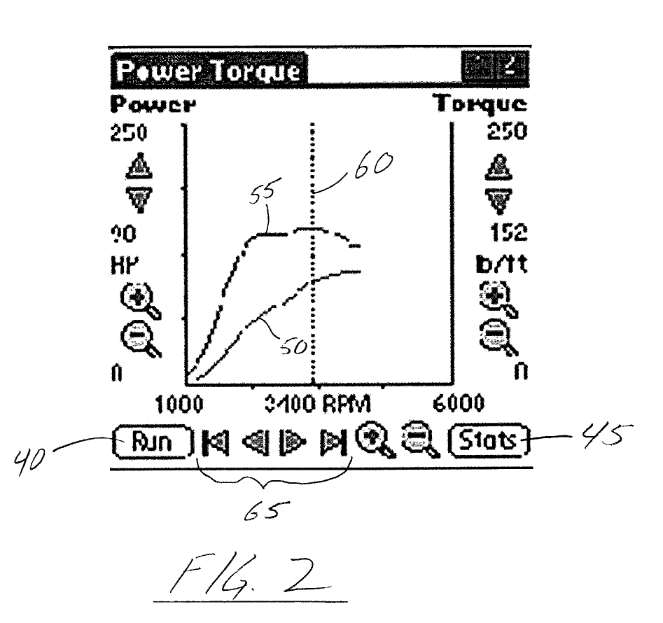

Referring to FIG. 2, a software program or module comprising computer readable program code constructed according to the present invention generates a computer display, as shown in FIG. 2, of a vehicle power and vehicle torque by manipulating vehicle data obtained from the vehicle network.

Vehicle manufacturers generally provide a vehicle engine horsepower number. However, this number is not representative of the actual horsepower that is delivered to the driving wheel or wheels of the vehicle because the vehicle engine must first transfer power through the transmission which then transfers the power through a drive shaft which then transfers the power through a ring-and-pinion gear set which then transfers the power through half-shafts which then transfer the power to the driving wheel(s). Each time the power is transferred from one device to the next, some power is lost and the actual horsepower generated at the driving wheel(s) can be as much as 10 to 20% less than that generated by the vehicle engine.

The present invention, using data obtained from the vehicle network, can calculate a horsepower available at a vehicle's driving wheel(s), herein referred to as vehicle power. Once the vehicle power, or driving wheel power is obtained, an available vehicle engine torque can also be obtained. Obtaining the driving wheel power and the vehicle engine torque quickly and easily can help a vehicle operator to determine whether a change to a vehicle system has improved the vehicle's performance. For example, after installing a high-flow air filter, high-voltage ignition coil or other performance-enhancing device, a vehicle owner can then employ the present invention and determine whether the vehicle power or vehicle torque has increased. Prior to the present invention, a vehicle power or vehicle torque would be obtained by testing the vehicle on a dynamometer, or other device. One feature of the present invention is that vehicle data, such as vehicle power and vehicle torque, can be quickly determined by using data obtained from the vehicle network.

A software module or computer readable program code constructed according to the present invention for determining a vehicle power using data obtained from a vehicle network will now be explained. Power is the rate of doing work or the amount of work done in a unit time. Work is the transfer of energy, and an amount of work done is equal to the force applied multiplied by the distance traveled in the direction of that force. Therefore,

Work=(Force)(Distance Traveled)

Because power is the rate of doing work or the amount of work done in a unit time, the power produced is the work done divided by the time taken.

$$Power = \frac{( Force ) ( Distance Traveled )}{T time}$$

From the power equation listed above, force can be determined because force is equal to the product of mass and acceleration.

Force=(Mass)(Acceleration)

Acceleration is the rate of change of velocity (speed) or the average increase of velocity in a unit of time, usually expressed in feet per second.

$$Acceleration = \frac{{V}_{2} - {V}_{1}}{{T}_{2} - {T}_{1}}$$

Where V₂ is an end velocity, V₁ is an initial velocity, T₂ is an end time and T₁ is an initial time. The distance traveled can be obtained by finding the quotient of the change in velocity and twice the amount of time required for the change in velocity.

$$Distance Traveled = \frac{{V}_{2} - {V}_{1}}{2 ( {T}_{2} - {T}_{1} )}$$

Where V₂ is an end velocity, V₁ is an initial velocity, T₂ is an end time, and T₁ is an initial time.

When these equations are combined, an equation for determining a vehicle power, or driving wheel power is arrived at:

$$Power = \frac{m ( {V}_{2} - {V}_{1} )}{\frac{2 ( {T}_{2} - {T}_{1} )}{1000}}$$

Where m is the vehicle weight, V₂ is an end velocity, V₁ is an initial velocity, T₂ is an end time, and T₁ is an initial time. The unit for Power in this equation is kilowatts. Kilowatts can be converted to horsepower by dividing kilowatts by 1.34. The resulting horsepower number is the horsepower available at the vehicle's driving wheel(s).

One feature of the present invention is that the above-described vehicle power software module must only obtain the end velocity V₂, the initial velocity V₁, the end time T₁, and the initial time T₁, to generate a vehicle power. The user will input the vehicle mass, or weight.

A preferred embodiment of the power software module may also use data related to the frontal area of the vehicle to generate a vehicle power. Specifically, the vehicle power number generated by the above-described power software module will be more accurate if the force that is used to overcome aerodynamic drag is also include in the vehicle power calculation. Vehicle frontal area, or cross-sectional area is the area of the front profile of the vehicle. The frontal area is component of the power loss due to aerodynamic drag. That is, engine power is required to overcome the drag caused by forcing a vehicle though the air, and the power required increases as vehicle speed increases.

One embodiment of the present invention may include a list, such as: small car, compact, sedan, sport-utility vehicle, and truck. The user will choose the appropriate vehicle type, and the vehicle power software will apply a correction factor and reduce the vehicle power number, to reflect the engine power lost to overcome aerodynamic drag.

Another embodiment of the power software module may employ an altitude correction factor. Engine power decreases as altitude increases, because air density decreases as altitude increases. One embodiment of the present invention may allow a user to input the altitude. An appropriate correction factor may then be included in the vehicle power calculation performed by the power software module.

Yet another embodiment of the power software module may include a tire rolling resistance correction factor. Each vehicle tire has a rolling resistance, and an amount of engine power is required to overcome the total amount of rolling resistance generated by all of the vehicle's tires. One embodiment of the present invention may allow a user to input a tire rolling resistance, or a list of tire rolling resistance values may be presented, and the user will be able to select from the list. For example, the list may present a selection of tire sizes, the user will select a tire size, and the power software module will apply a tire rolling resistance correction factor appropriate for the chosen tire size.

Another embodiment of the present invention may include an actual vehicle engine horsepower software module. This software module will calculate an approximation of the horsepower generated by the vehicle engine. As discussed above, the power delivered to the driving wheels of the vehicle is 10 to 20% less than the power generated by the engine. The actual vehicle engine horsepower software module will include several correction factors to generate a close approximation of the actual power generated by the vehicle engine. For example, the actual vehicle engine horsepower software module may have the user select either a stick-shift transmission or an automatic transmission, and may also have the user select either a front-wheel drive or a rear-wheel drive. Correction factors for each type of vehicle configuration will be included in the actual vehicle engine horsepower software module, which will use the information to generate a vehicle engine horsepower.

Referring to FIG. 2, a computer display is illustrated, with the vehicle power depicted graphically. The software module constructed according to the present invention can be installed in a general computing device such as PDA, laptop or other type of display unit 35, and in a preferred embodiment of the present invention, will generate a display substantially as illustrated in FIG. 2.

An operator wishing to obtain a vehicle power will initiate the software module by using a stylus or other object and strike or contact the run button 40. At that instant, the initial time T₁ is set and the vehicle is preferably accelerated at maximum acceleration until the user strikes the stats button 45 stopping the test and setting the end time T₂. The software module obtains the vehicle's initial velocity V₁ at the initial time T₁ and obtains the vehicle's end velocity V₂ at the end time T₂. The initial velocity V₁ and end velocity V₂ are obtained by accessing the vehicle network through the OBD connector in the passenger compartment. The software module then obtains the difference between the initial velocity V₁ and the end velocity V₂ and also obtains the total elapsed time, which is the difference between T₂ and T₁, and calculates the vehicle power, which represents the available horsepower at the vehicle's driving wheel(s). A power curve 50 is graphically displayed on the display unit 35 as shown in FIG. 2.

Once the vehicle power has been determined, a vehicle torque can also be obtained by the following equation.

$$Torque = Power ( \frac{5 \text{,} 252}{RPM} )$$

Where RPM is the engine revolutions-per-minute.

The software module then calculates the vehicle engine torque by using the above equation, and displays a torque curve 55 as shown in FIG. 2. Also shown in FIG. 2 is a scroll bar 60 that can be moved by tapping or contacting the arrow buttons 65. The scroll bar provides an instantaneous data readout of the vehicle power or vehicle torque at a specific engine RPM. Thus, a software module or computer readable program code constructed according to the present invention manipulates vehicle data obtained from a vehicle network or OBD system to obtain data not originally provided by the vehicle network or OBD system. Namely, a vehicle power and a vehicle torque. This data can then be used by a technician or vehicle owner to determine any difference in a vehicle's performance before and after a modification, such as the installation of a high-flow air filter or high-voltage ignition coil.

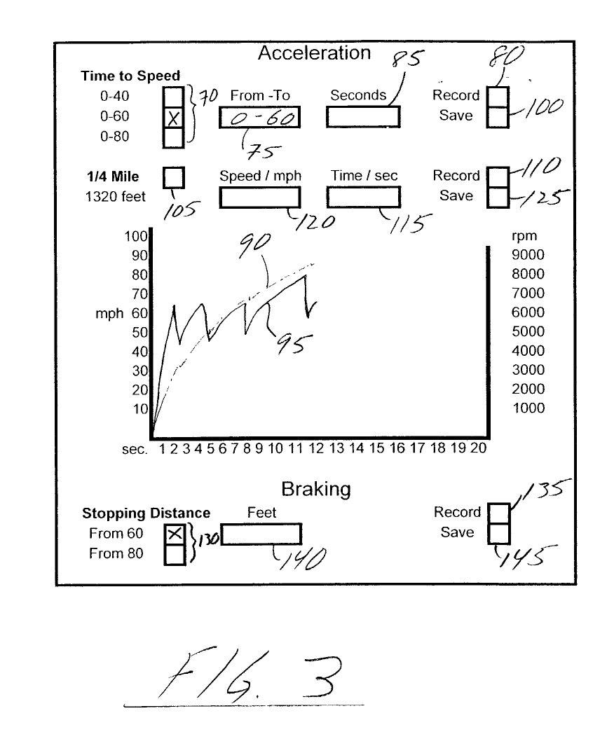

Referring to FIG. 3, a second software module comprising computer readable program code constructed according to the present invention generates a computer display, as shown in the Figure, of a vehicle acceleration and a vehicle engine revolutions-per-minute (RPM). The software acceleration module can measure any number of different vehicle accelerations or decelerations, such as 0 to 60 miles-per-hour (mph) or kilometers-per-hour (kph), 40 to 80 mph, 80 to 0 mph, 40 to 0 mph, or acceleration over ¼ mile. It will be appreciated that other vehicle accelerations or decelerations can also be calculated and displayed.

For example, referring to FIG. 3, which is displayed on a display unit 35, the user employs a stylus, finger or other device to designate the specific acceleration data desired in the Time to Speed buttons 70. The designated acceleration test is then displayed by the acceleration software module in the From-To box 75. In the example illustrated in FIG. 3, an acceleration from 0 to 60 mph has been chosen by a user. The user then strikes or contacts the record button 80 with a stylus or other device. As soon as the record button 80 is designated, the acceleration software module obtains an initial time T₁. The acceleration software module then monitors the vehicle speed by accessing a vehicle network through the OBD-II connector and when the vehicle speed reaches 60 mph, the acceleration software module obtains an end time T₂. The acceleration software module then displays the total amount of time required to accelerate from 0 to 60 mph in the seconds box 85.

Also shown in FIG. 3, the acceleration software module displays the vehicle acceleration 90 and the vehicle RPM 95 graphically. The user then has the choice of whether or not to save the specific acceleration test by striking the acceleration test save button 100. Once the acceleration test save button 100 has been designated, the acceleration test is saved in the display unit 35. One feature of the present invention is that a user can review and compare different acceleration tests to determine changes in vehicle performance.

Another function of the acceleration software module is the manipulation of vehicle data obtained from a vehicle network to obtain a ¼ mile data. If a user wishes to obtain data on vehicle performance over a ¼ mile, the ¼ mile button 105 is designated. The user then designates the ¼ mile record button 110 to start the test. The acceleration software module then obtains an initial time T₁ from the display unit 35 when the vehicle starts moving. Specifically, the acceleration software module accesses the vehicle network to determine when the vehicle starts moving. For example, the data may be obtained from a vehicle wheel speed sensor. When the vehicle begins to move, the acceleration software module obtains the initial time T₁ from the display unit 35.

The acceleration software module then continues to obtain data from the vehicle network and when the vehicle has traveled a quarter mile, the acceleration software module obtains an end time T₂. The acceleration software module then obtains a difference between the end time T₂ and the initial time T₁ and displays this time difference in the Time/sec box 115. The acceleration software module also obtains the vehicle speed at the point the vehicle traveled the ¼ mile distance and displays that in the Speed/mph box 120. The user then can choose to save this specific ¼ mile test by designating the ¼ mile save button 125. The data is then saved in the display unit 35. One feature of the present invention is that a user can review and compare different ¼ mile tests to determine changes in vehicle performance.

Another function of the acceleration software module is the breaking, or stopping distance, function also illustrated in FIG. 3. The user can designate the distance over which the acceleration software module will obtain data by designating a specific stopping distance box 130. The user then designates the stopping distance record button 135 and the acceleration software module accesses the vehicle network and monitors the vehicle speed or velocity. The designated test example illustrated in FIG. 3 is a 60 to 0 stopping distance test and so the acceleration software module will begin recording the distance traveled once the vehicle hits 60 mph or kph. When the vehicle comes to a complete stop, the acceleration software module obtains the total distance traveled by the vehicle from 60 mph to rest and displays that number in the feet box 140. If the user wishes to save this test data, the user designates the stopping distance save box 145. One feature of the present invention is that a user can review and compare different stopping distance tests to determine changes in vehicle performance.

Alternative embodiment software modules may include the capability for the user to enter different stopping distances or different time-to-speed numbers so the user can choose the exact distance or exact speed from which to obtain data.

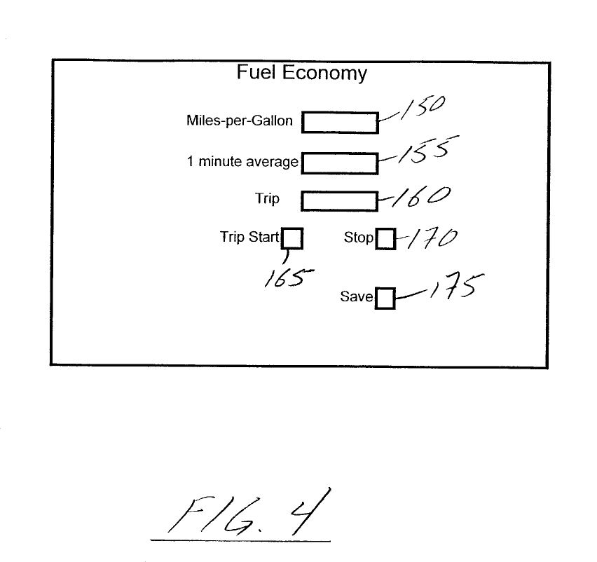

Referring to FIG. 4, a fuel economy software program or module comprising a computer readable program code constructed according to the present invention generates a computer display, as shown in FIG. 4, of a vehicle fuel economy by manipulating vehicle data obtained from the vehicle network. One feature of the present invention is the fuel economy software module employs an air-to-fuel ratio of 14.7:1. That is, to achieve the current exhaust emission standards required by Federal and State governments, vehicle manufacturers employ a 14.7:1 air/fuel ratio. This specific fuel ratio is used to achieve the required vehicle emission standards. The present invention employs this air/fuel ratio to determine the vehicle economy.

As shown in FIG. 4, the vehicle fuel economy can be displayed in either a miles-per-gallon display 150, a 1 minute average display 155, or a vehicle trip display 160. A user starts the fuel economy software module by designating the trip start box 165. The fuel economy software module then accesses the vehicle network through the OBD-II connector and begins to obtain the mass of the air that is passing through the vehicle engine intake manifold. When the user designates the stop button 170, the fuel economy software module calculates the total mass of air that passed through the vehicle intake manifold during the test period and calculates the fuel used by applying the 14.7:1 air/fuel ratio to the mass of the air. Specifically, the air/fuel ratio affirms that for every unit of fuel used, 14.7 units of air are also used. Therefore, the fuel economy software module divides the total mass of the air used during the test by 14.7 to determine the total mass of fuel that was used during the test. The fuel economy software module also obtains the total distance traveled by the vehicle during the test. Once the total amount of fuel is determined and the total distance traveled is determined, the fuel economy software module then calculates the trip fuel economy, the 1 minute average fuel economy and the miles-per-gallon fuel economy. To determine the 1 minute average fuel economy, the fuel economy software module also obtains the total elapsed time for the test and calculates the 1 minute average. Each of these calculated values is displayed in the appropriate display area as shown in FIG. 4. At the end of test, the user can then designate the fuel economy save box 175 to save the test data in the display unit 35. One feature of the present invention is that a user can review and compare different fuel economy tests to determine changes in vehicle performance.

Thus, it is seen that a vehicle data display system and method is provided. One skilled in the art will appreciate that the present invention can be practiced by other than the above-described embodiments, which are presented in this description for purposes of illustration and not of limitation. The description and examples set forth in this specification and associated drawings only set forth preferred embodiment(s) of the present invention. The specification and drawings are not intended to limit the exclusionary scope of this patent document. Many designs other than the above-described embodiments will fall within the literal and/or legal scope of the following claims, and the present invention is limited only by the claims that follow. It is noted that various equivalents for the particular embodiments discussed in this description may practice the invention as well.

What is claimed is:

1. A computer program product for directing a general purpose digital computer to perform a desired function comprising:
a set of computer readable instructions to obtain a vehicle power, the computer readable instructions using a vehicle mass, vehicle network data, and time data.

2. The computer program product of claim 1, wherein the vehicle power comprises a power generated at a driving wheel of the vehicle.

3. The computer program product of claim 1, wherein the general purpose digital computer is directed to perform method steps to obtain the vehicle power, the method steps comprising:
multiplying the vehicle mass by a vehicle acceleration to obtain a vehicle force;
multiplying the vehicle force by a distance value, to obtain a product; and
dividing the product by a time value.

4. The computer program product of claim 3, wherein the general purpose digital computer is directed to perform method steps to obtain the vehicle acceleration, the method steps comprising:
obtaining from a vehicle network a first velocity;
establishing a start time when the first velocity is obtained;
obtaining from the vehicle network a second velocity;
establishing an end time when the second velocity is obtained;
subtracting the first velocity from the second velocity to obtain a velocity difference;
subtracting the start time from the end time to obtain a time difference; and
dividing the velocity difference by the time difference.

5. The computer program product of claim 3, wherein the general purpose digital computer is directed to perform method steps to obtain the distance value, the method steps comprising:
obtaining from a vehicle network a first velocity;
establishing a start time when the first velocity is obtained;
obtaining from the vehicle network a second velocity;
establishing an end time when the second velocity is obtained;
subtracting the first velocity from the second velocity to obtain a velocity difference;
subtracting the start time from the end time to obtain a time difference;
multiplying the velocity difference by the time difference to obtain a product; and
dividing the product by 2.

6. The computer program product of claim 3, wherein the general purpose digital computer is directed to perform method steps to obtain the time value, the method steps comprising:
establishing a start time when a first velocity is obtained from a vehicle network;
establishing an end time when a second velocity is obtained from the vehicle network;
subtracting the start time from the end time.

7. The computer program product of claim 1, wherein a vehicle network comprises an OBD-II system.

8. The computer program product of claim 1, wherein a vehicle network employs a standard selected from the group consisting of: SAE J1850, SAE J1850 VPW, SAE J1850 PWM, ISO 9141, ISO 9141-2, ISO 9141 CARB, and ISO 14230.

9. The computer program product of claim 1, wherein a vehicle network is a controller area network.

10. The computer program product of claim 9, wherein the data received from the controller area network employs a standard selected from the group consisting of: ISO 11898, ISO 11519, SAE J2411, SAE J1939, and SAE J1708.

11. The computer program product of claim 1, wherein a vehicle network is an Intelligent Transportation Systems Data Bus.

12. The computer program product of claim 11, wherein the data received from the Intelligent Transportation Systems Data Bus employs a standard selected from the group consisting of: SAE J2355, SAE J2366, SAE J2367 and SAE J2368.

13. The computer program product of claim 1, wherein the general purpose digital computer is selected from the group consisting of: a personal digital assistant, a portable computer, a laptop computer, a portable phone, an electronic assistant, an electronic organizer, an electronic notepad, a hand-held computer, and a global computer network.

14. The computer program product of claim 1, wherein the computer program is stored on a medium selected from the group consisting of: a compact disk, a floppy disk, and a flash memory module.

15. The computer program product of claim 1, wherein the computer program is stored on general purpose digital computer, and can be accessed through a global computer network.

16. The computer program product of claim 1, wherein the set of computer readable instructions to obtain the vehicle power includes an aerodynamic drag correction factor.

17. The computer program product of claim 1, wherein the set of computer readable instructions to obtain the vehicle power includes an altitude correction factor.

18. The computer program product of claim 1, wherein the set of computer readable instructions to obtain the vehicle power includes a tire rolling resistance correction factor.

19. A computer program product for directing a general purpose digital computer to perform a desired function comprising:
a set of computer readable instructions to obtain a vehicle acceleration, the instructions using data received from a vehicle network, and time data.

20. The computer program product of claim 19, wherein the general purpose digital computer is directed to perform method steps to obtain the vehicle acceleration, the method steps comprising:
obtaining from the vehicle network a first velocity;
establishing a start time when the first velocity is obtained;
obtaining from the vehicle network a second velocity;
establishing an end time when the second velocity is obtained;
subtracting the first velocity from the second velocity to obtain a velocity difference;
subtracting the start time from the end time to obtain a time difference; and
dividing the velocity difference by the time difference.

21. A method for obtaining a vehicle acceleration, the method steps comprising:
obtaining from a vehicle network a first velocity;
establishing a start time when the first velocity is obtained;
obtaining from the vehicle network a second velocity;
establishing an end time when the second velocity is obtained;
subtracting the first velocity from the second velocity to obtain a velocity difference;
subtracting the start time from the end time to obtain a time difference; and
dividing the velocity difference by the time difference.

22. The method of claim 21, wherein the data received from the vehicle network is received from an OBD-II system.

23. The method of claim 21, wherein the data received from the vehicle network is received from an OBD-II system employing a SAE J1850 communication protocol.

24. The method of claim 21, wherein the data received from the vehicle network is received from an OBD-II system employing an ISO 9141 communication protocol.

25. The method of claim 21, wherein the general purpose digital computer is selected from the group consisting of: a personal digital assistant, a portable computer, a laptop computer, a portable phone, an electronic assistant, an electronic organizer, an electronic notepad, a hand-held computer, and a global computer network.

26. The method of claim 21, wherein the computer program is stored on a medium selected from the group consisting of: a compact disk, a floppy disk, a flash memory module, and a general purpose digital computer.

27. The method of claim 21, wherein the computer program is stored on general purpose digital computer, and can be accessed through a global computer network.

28. A computer program product for directing a general purpose digital computer to perform a desired function comprising:
a set of computer readable instructions to obtain a vehicle torque, the instructions using a vehicle mass, vehicle network data, and time data.

29. The computer program product of claim 28, wherein the vehicle torque comprises an approximation of a vehicle engine torque.

30. The computer program product of claim 28, wherein the general purpose digital computer is directed to perform method steps to obtain the vehicle torque, the method steps comprising:
obtaining a vehicle engine revolutions-per-minute;
dividing 5,252 by the vehicle engine revolutions-per-minute, to obtain a quotient; and
multiplying a vehicle power by the quotient.

31. The computer program product of claim 30, wherein the vehicle power comprises a power generated at a driving wheel of the vehicle.

32. A method for obtaining a vehicle torque, the method steps comprising:
obtaining a vehicle engine revolutions-per-minute;
dividing 5,252 by the vehicle engine revolutions-per-minute, to obtain a quotient; and
multiplying a vehicle power by the quotient.

33. The method of claim 32, wherein the vehicle power comprises a power generated at a driving wheel of the vehicle.

34. A computer program product for directing a general purpose digital computer to perform a desired function comprising:
a set of computer readable instructions to obtain a vehicle fuel economy, the instructions using data received from a vehicle network, and an air-to-fuel ratio.

35. The computer program product of claim 34, wherein the air-to-fuel ratio is approximately 14.7 to 1.

36. The computer program product of claim 34, wherein the general purpose digital computer is directed to perform method steps to obtain the vehicle fuel economy, the method steps comprising:
obtaining a mass of air that passed through a vehicle intake manifold during a defined time period;
dividing the mass of air by 14.7, to obtain a fuel mass;
obtaining a distance traveled during the defined time period; and
dividing the distance traveled by the fuel mass.

37. A method for obtaining a vehicle fuel economy, the method steps comprising:
obtaining a mass of air that passed through a vehicle intake manifold during a defined time period;
dividing the mass of air by 14.7, to obtain a fuel mass;
obtaining a distance traveled during the defined time period; and
dividing the distance traveled by the fuel mass.

38. A method for obtaining a vehicle power, the method comprising the steps of:
multiplying the vehicle mass by a vehicle acceleration to obtain a vehicle force;
multiplying the vehicle force by a distance value, to obtain a product; and
dividing the product by a time value.

39. The method of claim 38, wherein the vehicle power comprises a power generated at a driving wheel of the vehicle.

40. The method of claim 38, wherein the method steps for obtaining the vehicle acceleration comprises the steps of:
obtaining from a vehicle network a first velocity;
establishing a start time when the first velocity is obtained;
obtaining from the vehicle network a second velocity;
establishing an end time when the second velocity is obtained;
subtracting the first velocity from the second velocity to obtain a velocity difference;
subtracting the start time from the end time to obtain a time difference; and
dividing the velocity difference by the time difference.

41. The method of claim 38, wherein the method steps for obtaining the distance value comprises the steps of:
obtaining from a vehicle network a first velocity;
establishing a start time when the first velocity is obtained;
obtaining from the vehicle network a second velocity;
establishing an end time when the second velocity is obtained;
subtracting the first velocity from the second velocity to obtain a velocity difference;
subtracting the start time from the end time to obtain a time difference;
multiplying the velocity difference by the time difference to obtain a product; and
dividing the product by 2.

42. The method of claim 38, wherein the method for obtaining the time value comprises the steps of:
establishing a start time when a first velocity is obtained from a vehicle network;
establishing an end time when a second velocity is obtained from the vehicle network;
subtracting the start time from the end time.
